(19) United States
(12) Patent Application Publication
(10) Pub. No.: US 2006/0203303 A1
(43) Pub. Date: Sep. 14, 2006

(54) Transparent scanning apparatus

(76) Inventor: Chih-Hsien Wei, Taipei City (TW)

Correspondence Address: RABIN & Berdo, PC, 1101 14TH STREET, NW, SUITE 500, WASHINGTON, DC, 20005, US

(21) Appl. No.: 11/155,476

(22) Filed: Jun. 20, 2005

(30) Foreign Application Priority Data
Mar. 11, 2005 (TW) 94107557

(51) Int. Cl. H04N 1/04

(52) U.S. Cl. 358/487

(57) ABSTRACT

A transparent scanning apparatus includes a scanner and a transparent document holding module. The scanner includes an optical module, which has a plurality of lighting units, for scanning. The transparent document holding module is located in the scanner and holds a transparent document. The side of the main body corresponds to the lighting units for altering the direction of light projecting to the transparent document. Thus, the light passes through the transparent document to reach the optical module to scan images of the transparent document.

### FIELD OF THE INVENTION

The invention relates to a scanning apparatus, and particularly to a scanning apparatus for scanning transparent documents and reflective documents.

### BACKGROUND OF THE INVENTION

The technique of using a scanning apparatus to scan documents is well-known in the art. Regardless of transparent documents or opaque documents, a light source has to be provided for emitting light, which projects to the document and enters into an optical module in the scanning apparatus for performing image scanning. For scanning opaque documents, the light emitted by the light source projects to the document which reflects the light to the optical module for performing image scanning of the opaque document. For scanning transparent documents, the light emitted from the light source penetrates the document to reach the optical module so as to perform image scanning of the transparent document. Hence, the conventional dual-purpose scanners for transparent documents and reflective documents mostly have the reflective light source installed in the scanner host, and have the transparent light source installed in the lid of the scanner, but such a design has two independent light sources and takes a great deal of space, which means that more elements are needed and the cost is higher.

To remedy the aforesaid problems, scanners that can scan transparent documents and reflective documents through using one light source have been developed. For instance, R.O.C. patent publication No. I220095 discloses a technique that has a lid including a reflective mirror and a light guide plate. Light emitted from a light source passes through two sides of the transparent document and is reflected by the reflective mirror to the light guide plate. The light guide plate directs the light to pass through the transparent document for performing scanning. Such a design can reduce the number of elements and save costs partially. However, it still requires a great deal of space.

### SUMMARY OF THE INVENTION

In view of the aforesaid problems, the invention is to provide a transparent scanning apparatus that is capable of scanning reflective documents and transparent documents.

The transparent scanning apparatus of the invention includes a scanner and a transparent document holding module. The scanner includes a host and a lid pivotally coupled to the host. The host includes an optical module for scanning. The optical module has a plurality of lighting units. The transparent document holding module is located between the host and the lid, and includes a main body and a light guide element which is located on the periphery of the main body. The main body holds a transparent document. The light guide element has an incident section, an emergent section and a reflective section on the outer surface. The incident section abuts against one side of the main body corresponding to the lighting units. The emergent section is adjacent to one surface of the main body which corresponds to the transparent document for altering the direction of light projecting to the transparent document. Hence, when the lighting unit emits light, the light enters the light guide element through the incident section, is reflected by the reflective section, emits through the emergent section, and passes through the transparent document to reach the optical module for performing image scanning of the transparent document.

Hence, the transparent scanning apparatus of the invention, in addition to scanning the transparent documents, also can scan reflective documents. Compared with the conventional techniques that have to install the transparent light source in the lid for scanning the transparent documents, the invention saves a lot of space. The light guide element of the invention can reflect the incident light inside without incurring much energy loss. Hence, light emitting diodes may be used as the light source of the lighting units. Moreover, compared with the scanning apparatus that can scan only reflective documents, the invention, by merely adding the lighting units and the light guide element, can perform image scanning of transparent documents. Compared with the conventional techniques that have to install the light source in the lid, the invention saves the cost of many elements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is a schematic view of a first embodiment of the invention showing the relative position of the optical module and the transparent document holding module.

FIG. 3 is a schematic view of the first embodiment of the invention showing the structure of the optical module.

FIG. 4 is a schematic view of the first embodiment of the invention showing the relative position of the transparent document holding module and the transparent document.

FIG. 5 is a schematic view of the first embodiment of the invention showing the direction of light travel when the transparent document holding module is used.

FIG. 6 is a schematic view of the first embodiment of the invention in a use condition.

FIG. 7 is a schematic view of a second embodiment of the invention showing the relative position of the optical module and the transparent document holding module.

FIG. 8 is a schematic view of the second embodiment of the invention showing the structure of the optical module.

FIG. 9 is a schematic view of the second embodiment of the invention showing the direction of light travel when the transparent document holding module is used.

FIG. 10 is a schematic view of the second embodiment of the invention in a use condition.

FIG. 11 is a perspective view of a third embodiment of the invention.

### DESCRIPTION OF THE PREFERRED EMBODIMENTS

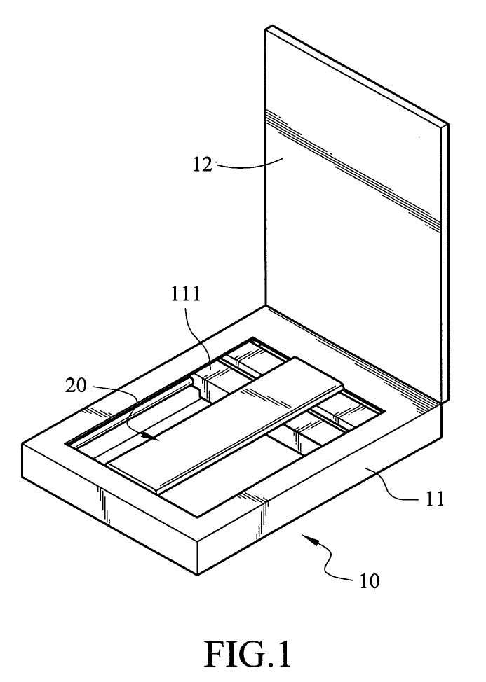

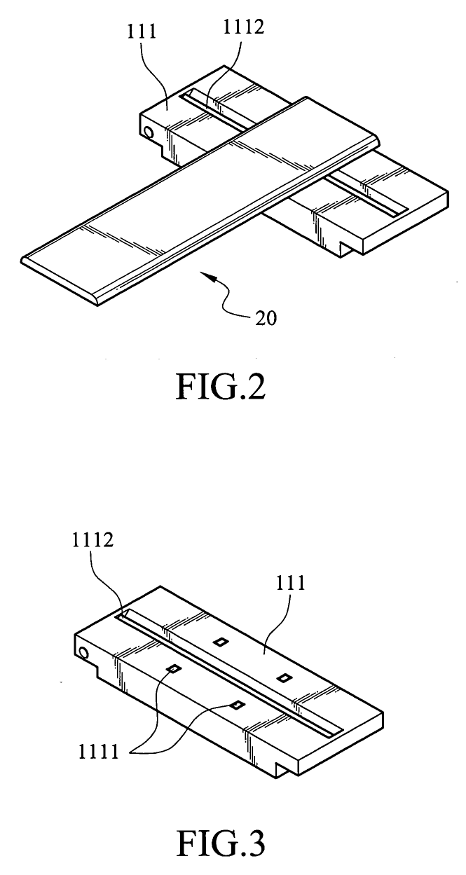

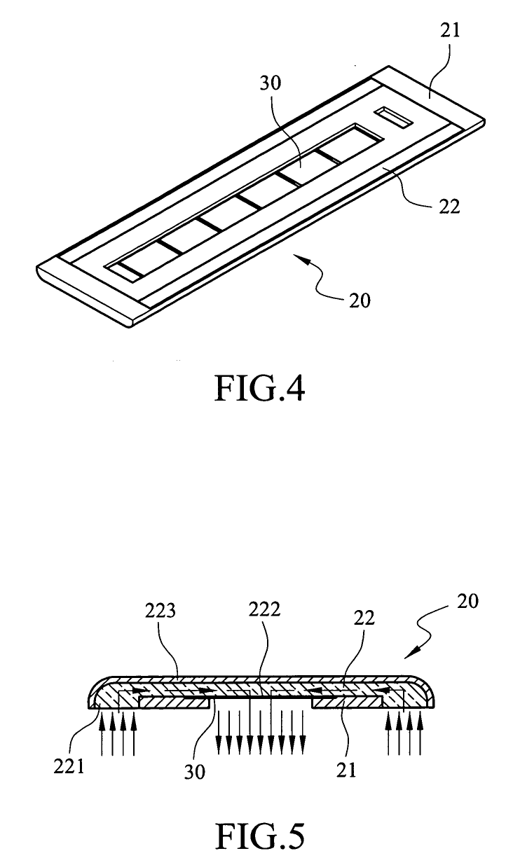

Refer to FIG. 1 for an embodiment of the structure of the invention, FIG. 2 for the relative position of the optical module and the transparent document holding module of a first embodiment, FIG. 3 for the optical module of the first embodiment, FIG. 4 for the relative position of the transparent document holding module and the transparent document, and FIG. 5 for the direction of light travel when the transparent document holding module is used according to the first embodiment. The transparent scanning apparatus according to the invention includes a scanner 10 and a transparent document holding module 20.

The scanner 10 includes a host 11 and a lid 12 pivotally coupled to the host 11. The host 1 includes an optical module 111 for scanning. The optical module 111 has a plurality of lighting units 1111 and a lamp 1112. The lighting units 1111 are light emitting diodes.

The transparent document holding module 20 is located between the host 11 and the lid 12, and includes a main body 21 and a light guide element 22 located on the periphery of the main body 21. The main body 21 holds a transparent document 30. The light guide element 22 may be made from polymers such as poly carbonate, acrylic and the like, and includes an incident section 221, an emergent section 222, and a reflective section 223 on the outer surface. The incident section 221 abuts against one side of main body 21 corresponding to the lighting units 1111. The emergent section 222 is adjacent to one surface of the main body 21 which corresponds to the transparent document 30 for altering the direction of light projecting to the transparent document 30. The surface of the emergent section 222 is not a smooth surface to evenly disperse emitting light.

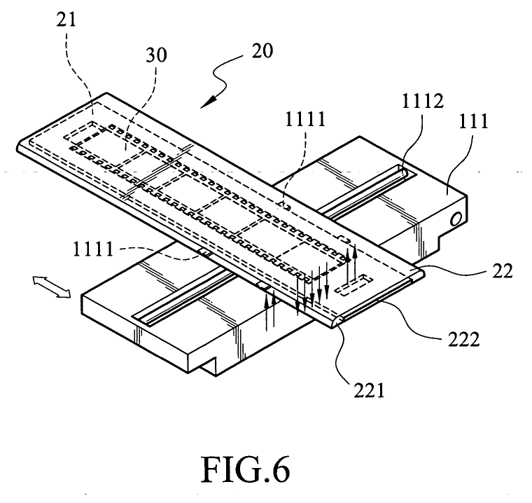

Refer to FIG. 6 for the first embodiment in a use condition. While scanning the transparent document 30, light, which is emits from the lighting units 1111, projects through the incident section 222 into the light guide element 22, is reflected by the reflection section 223, emits through the emergent section 222, and passes through the transparent document 30 to reach the optical module 111 for scanning the images of the transparent document 30. While scanning the transparent document 30, the lamp 1112 does not emit light, so no light is projected from the host 11 towards the lid 12 to affect image scanning of the transparent document 30. Moreover, even if there is light projecting from the direction of the host 11 towards the lid 12, the light guide element 22 can still direct the light from the lid 12 towards the host 11 to reach the optical module 111 for scanning the images of the transparent document 30. Of course, scanning of reflective documents can be accomplished through the lamp 1112. This is a technique known in the art so details are omitted.

The transparent scanning apparatus of the invention can scan both transparent documents 30 and reflective documents. Compared with the conventional techniques that have to install a transparent light source in the lid (not shown in the drawings) for scanning transparent documents, the invention saves a lot of space. The light guide element 22 of the invention can reflect the incident light inside without incurring much energy loss. Hence, light emitting diodes may be used as the light source of the lighting units 1111. Moreover, compared with the scanning apparatus that can scan only reflective documents, the invention, by merely adding the lighting units 1111 and the light guide element 22, can perform image scanning of the transparent document 30. Compared with the conventional techniques that have to install the light source in the lid, the invention saves the cost of many elements.

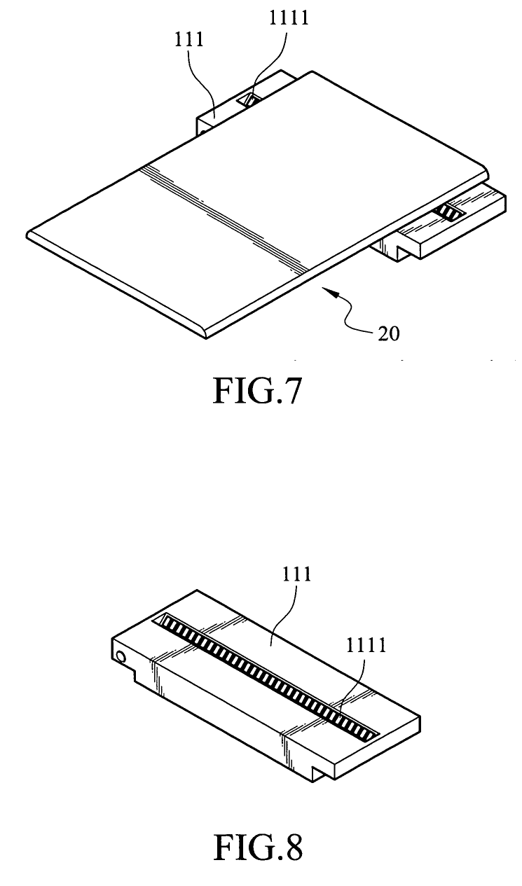

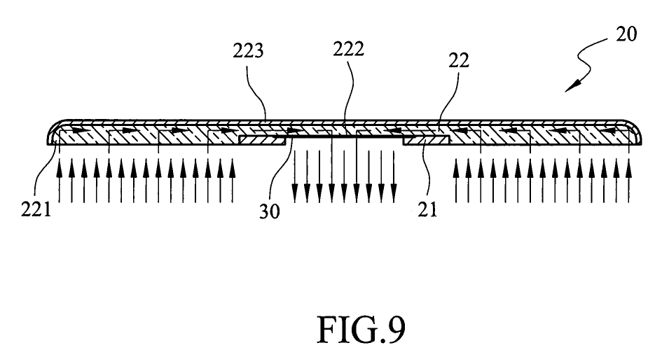

Refer to FIG. 1 for an embodiment of the structure of the invention, FIG. 7 for a second embodiment of the invention showing the relative position of the optical module and the document holding module, FIG. 8 for the optical module, and FIG. 9 for the direction of light travel when the transparent document holding module is used according to the second embodiment. The transparent scanning apparatus according to the invention includes a scanner 10 and a transparent document holding module 20.

The scanner includes a host 11 and a lid 12 pivotally coupled to the host 11. The host 11 includes an optical module 111 for scanning. The optical module 111 has a plurality of lighting units 1111. The lighting units 1111 are light emitting diodes. The lighting units 1111 are arranged on a straight line and can emit light or not emit light as needed.

The transparent document holding module 20 is located between the host 11 and the lid 12, and includes a main body 21 and a light guide element 22 located on the periphery of the main body 21. The main body 21 holds a transparent document 30. The light guide element 22 may be made from polymers such as poly carbonate, acrylic and the like, and includes an incident section 221, an emergent section 222, and a reflective section 223 on the outer surface. The incident section 221 abuts against one side of main body 21 corresponding to the lighting units 1111. The emergent section 222 is adjacent to one surface of the main body 21 which corresponds to the transparent document 30 for altering the direction of light projecting to the transparent document 30. The surface of the emergent section 222 is not a smooth surface to evenly disperse the emitting light.

In the second embodiment, most of the light emitted by the lighting units 1111 can be used as long as the light projecting from the incident section 221 is not blocked by the main body 21. Hence, the size of the incident section 221 may be larger than that of the first embodiment (referring to FIG. 5) for directing more light into the light guide element 22 to be reflected and emitted through the emergent section 222 to project to the transparent document 30. That is, more lighting units 1111 correspond to the incident section 221.

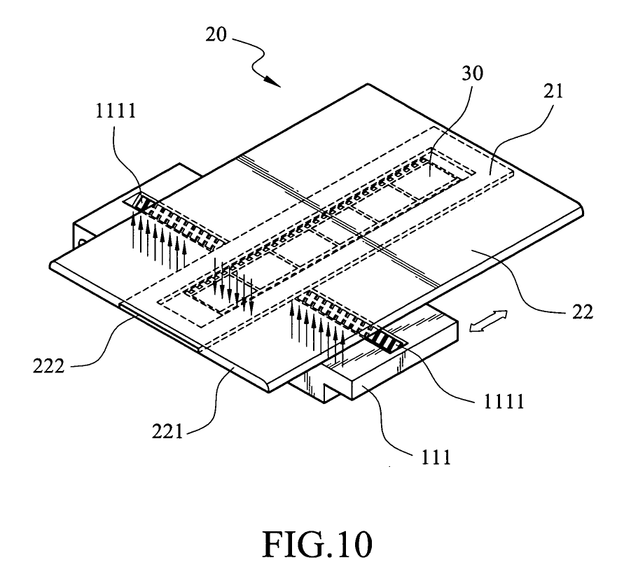

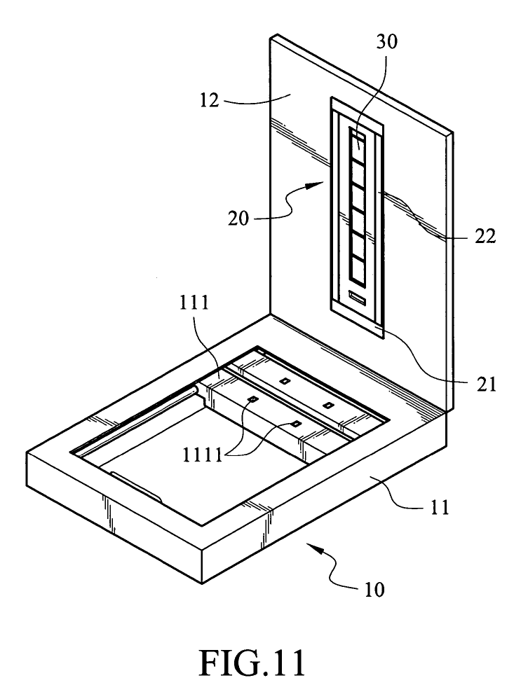

Refer to FIG. 10 for the second embodiment in a use condition. While scanning the transparent document 30, the lighting units 1111 corresponding to the incident section 221 emit light into the light guide element 22 through the incident section 222. The light is reflected by the reflection section 223, emits through the emergent section 222, and passes through the transparent document 30 to reach the optical module 111 for scanning the image of the transparent document 30. While scanning the transparent document 30, the lighting units 1111 not corresponding to the incident section 221 do not emit light. Hence, no light is projected from the host 11 towards the lid 12 to affect image scanning of the transparent document 30. Moreover, even if there is light projecting from the direction of the host 11 towards the lid 12, the light guide element 22 can still direct the light from the lid 12 towards the host 11 to reach the optical module 111 for scanning the images of the transparent document 30. Of course, scanning of reflective documents can be accomplished through the lighting units 1111. This is a technique known in the art so details are omitted.

The transparent scanning apparatus of the invention can scan both transparent documents 30 and reflective documents. Compared with the conventional techniques that have to install a transparent light source in the lid (not shown in the drawings) to scan transparent documents, the invention saves a lot of space. The light guide element 22 of the invention can reflect the incident light inside without incurring much energy loss. Hence, light emitting diodes may be used as the light source of the lighting units 1111. Moreover, compared with the scanning apparatus that can scan only reflective documents, the invention, by merely replacing the lamp 1112 with the lighting units 1111 and adding the light guide element 22, can perform image scanning of transparent documents 30. Compared with the conventional techniques that have to install the light source in the lid, the invention saves the cost of many elements.

In addition to the constructions set forth above, the invention can also be directly coupled to the lid 12. Refer to FIG. 11 for a third embodiment of the invention for such a structure. The transparent document 30 is held in the transparent document holding module 20 when in use. Once the scanner 10 is activated, scanning operation starts.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A transparent scanning apparatus, comprising:
a scanner, which includes a host and a lid pivotally coupled to the host, and the host has an optical module, which has a plurality of lighting units, for scanning; and
a transparent document holding module, which is located between the host and the lid, and which includes a main body for holding a transparent document and a light guide element that is located on the periphery of the main body and that includes an incident section abutting against one side of the main body and corresponding to the lighting units, an emergent section being adjacent to one surface of the main body which corresponds to the transparent document for altering the direction of light projecting to the transparent document, and a reflective section on the surface thereof.

2. The transparent scanning apparatus of claim 1, wherein the lighting units are light emitting diodes.

3. The transparent scanning apparatus of claim 2, wherein the lighting units are arranged on a straight line, and the lighting units has a portion corresponding to the incident section and is selectively to emit the light and not to emit the light.

4. The transparent scanning apparatus of claim 1, wherein the optical module further includes a lamp, which does not emit light when the lighting units emit the light.

5. The transparent scanning apparatus of claim 1, wherein the emergent section has a non-smooth surface.

6. The transparent scanning apparatus of claim 1, wherein the light guide element is made from polymers which are selected from the group consisting of poly carbonate and acrylic.

7. The transparent scanning apparatus of claim 1, wherein the transparent document holding module is coupled to the lid of the scanner.

8. A light guide element used in scanning a transparent document comprising an incident section, an emergent section and a reflective section on the surface thereof, the incident section receiving light which is reflected by the reflective section and is emitted through the emergent section such that the direction of light travel is altered to project to the transparent document for performing scanning.

9. The light guide element of claim 8, wherein the emergent section has a non-smooth surface.

10. The light guide element of claim 8, wherein the light guide element is made from polymers selected from the group consisting of poly carbonate and acrylic.

11. The light guide element of claim 1, wherein light, which emits from the lighting units, projects into the light guide element through the incident section, is reflected by the reflective section, emits through the emergent section, and passes through the transparent document to reach the optical module for scanning images of the transparent document.
